(19) United States
(12) Patent Application Publication
(10) Pub. No.: US 2024/0378124 A1
(43) Pub. Date: Nov. 14, 2024

(54) SYSTEMS AND METHODS FOR OPTIMIZING POST PACKAGE REPAIR IN ASSOCIATION WITH SOFTWARE MEMORY HEALING

(71) Applicant: Dell Products L.P., Round Rock, TX (US)

(72) Inventors: Balasingh P. SAMUEL, Round Rock, TX (US); Michael W. ARMS, Copperas Cove, TX (US); Lee B. ZARETSKY, Austin, TX (US)

(73) Assignee: Dell Products L.P., Round Rock, TX (US)

(21) Appl. No.: 18/314,030

(22) Filed: May 8, 2023

(51) Int. Cl. G06F 11/16

(52) U.S. Cl. CPC G06F 11/167; G06F 2201/865

(57) ABSTRACT

An information handling system may include a processor, a memory system communicatively coupled to the processor, the memory system comprising a plurality of spare rows for post-package repair of the memory system, and one or more instructions stored in non-transitory computer readable media and configured to, when executed, cause the processor to communicate a command to the memory system requesting information associated with an availability of spare rows for post-package repair of the memory system and receive a response to the command, the command comprising the information associated with the availability.

### TECHNICAL FIELD

The present disclosure relates in general to information handling systems, and more particularly to systems and methods for optimizing post-package repair in association with software memory healing in an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often use memories to store data. A type of memory often used is dynamic random access memory (DRAM). Demand for higher memory capacities on high-performance servers has propelled a corresponding consistent increase on the densities of DRAMs and, hence, on the memory modules themselves from one server generation to the next. DRAM densities of 8 GB have become commonplace in existing dual-inline memory modules (DIMMs), and as per projections by DIMM vendors, DRAM densities of 16 GB and even 32 GB may be used in coming years. In spite of the increase in the DRAM densities on modern DIMM modules, DIMM vendors' technical projections highlight an increasing likelihood of failure rates as the DRAM geometries continue to shrink to smaller process technologies. In that vein, DRAM row-based failures are becoming increasingly common with these smaller geometry-based DRAMs. Hence, an increase in both the number of DRAMs on a module and DRAM densities in these smaller process technologies calls for higher memory reliability, availability, and serviceability (RAS) capabilities than traditionally available.

Post-Package Repair (PPR) is one such new feature that was introduced in recent years to address the row-based failures. This feature allows for one or more spare rows per bank-group that can be used to replace a faulty row. The current industry standard for PPR is to replace a defective memory row when an error is detected, even in the presence of only a one-bit failure. Accordingly, the usage of spare rows may not be optimally applied to repair the maximum number of defective address locations in memory.

For example, a spare row could repair up to 64 defective memory locations in a memory bank group, but existing PPR memory healing approaches utilize the spare row for the first defective location, without any optimization. Further, only a limited number of spare rows may be available, and once used, a spare row cannot be reverted to reuse.

### SUMMARY

In accordance with the teachings of the present disclosure, the disadvantages and problems associated with utilizing post-package repair capability in an information handling system may be reduced or eliminated.

In accordance with embodiments of the present disclosure, an information handling system may include a processor, a memory system communicatively coupled to the processor, the memory system comprising a plurality of spare rows for post-package repair of the memory system, and one or more instructions stored in non-transitory computer readable media and configured to, when executed, cause the processor to communicate a command to the memory system requesting information associated with an availability of spare rows for post-package repair of the memory system and receive a response to the command, the command comprising the information associated with the availability.

In accordance with these and other embodiments of the present disclosure, a method may include communicating a command to a memory system comprising a plurality of spare rows for post-package repair of the memory system, the command for requesting information associated with an availability of spare rows for post-package repair of the memory system and receiving a response to the command, the command comprising the information associated with the availability.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to communicate a command to a memory system comprising a plurality of spare rows for post-package repair of the memory system, the command for requesting information associated with an availability of spare rows for post-package repair of the memory system and receive a response to the command, the command comprising the information associated with the availability.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system in accordance with embodiments of the present disclosure;

FIG. 2 illustrates a block diagram of an example memory chip in accordance with embodiments of the present disclosure;

FIG. 3 illustrates a block diagram of an example bank group, in accordance with embodiments of the present disclosure;

FIGS. 4A-4C illustrate the optimization process over time in response to a series of hypothetical memory defect occurrences, in accordance with embodiments of the present disclosure; and

FIG. 5 illustrates a flow chart of an example method for optimization of post package repair in association with software memory healing, in accordance with embodiments of the present disclosure.

### DETAILED DESCRIPTION

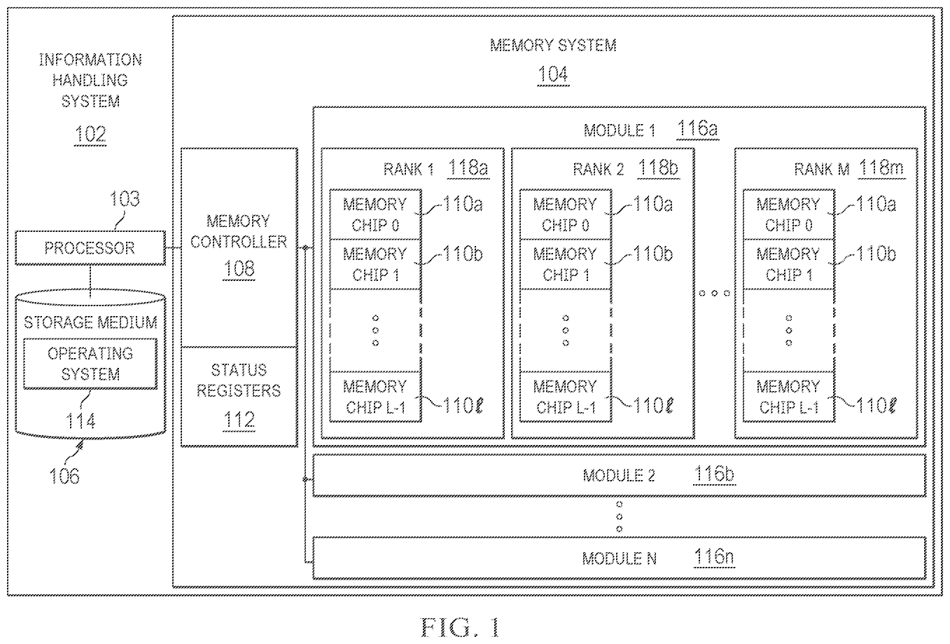

Preferred embodiments and their advantages are best understood by reference to FIGS. 1 through 5, wherein like numbers are used to indicate like and corresponding parts. For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components. For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example information handling system 102 in accordance with certain embodiments of the present disclosure. In certain embodiments, information handling system 102 may comprise a computer chassis or enclosure (e.g., a server chassis holding one or more server blades). In other embodiments, information handling system 102 may be a personal computer (e.g., a desktop computer or a portable computer). As depicted in FIG. 1, information handling system 102 may include a processor 103, a memory system 104 communicatively coupled to processor 103, and a storage medium 106 communicatively coupled to processor 103.

Processor 103 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored and/or communicated by one or more of memory system 104, storage medium 106, and/or another component of information handling system 102.

Memory system 104 may be communicatively coupled to processor 103 and may comprise any system, device, or apparatus operable to retain program instructions or data for a period of time (e.g., computer-readable media). Memory system 104 may comprise random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to information handling system 102 is turned off. In particular embodiments, memory system 104 may comprise dynamic random access memory (DRAM).

As shown in FIG. 1, memory system 104 may include memory controller 108, one or more memory modules 116a-116n communicatively coupled to memory controller 108, and status registers 112 communicatively coupled to memory controller 108. Memory controller 108 may be any system, device, or apparatus configured to manage and/or control memory system 104. For example, memory controller 108 may be configured to read data from and/or write data to memory modules 116 comprising memory system 104. Additionally or alternatively, memory controller 108 may be configured to refresh memory modules 116 and/or memory chips 110 thereof in embodiments in which memory system 104 comprises DRAM. Although memory controller 108 is shown in FIG. 1 as an integral component of memory system 104, memory controller 108 may be separate from memory system 104 and/or may be an integral portion of another component of information handling system 102 (e.g., memory controller 108 may be integrated into processor 103).

Each memory module 116 may include any system, device or apparatus configured to retain program instructions and/or data for a period of time (e.g., computer-readable media). A memory module 116 may comprise a dual in-line package (DIP) memory, a dual-inline memory module (DIMM), a Single In-line Pin Package (SIPP) memory, a Single Inline Memory Module (SIMM), a Ball Grid Array (BGA), or any other suitable memory module.

As depicted in FIG. 1, each memory module 116 may include one or more ranks 118a-118m. Each memory rank 118 within a memory module 116 may be a block or area of data created using some or all of the memory capacity of the memory module 116. In some embodiments, each rank 118 may be a rank as such term is defined by the Joint Electron Device Engineering Council (JEDEC) Standard for memory devices.

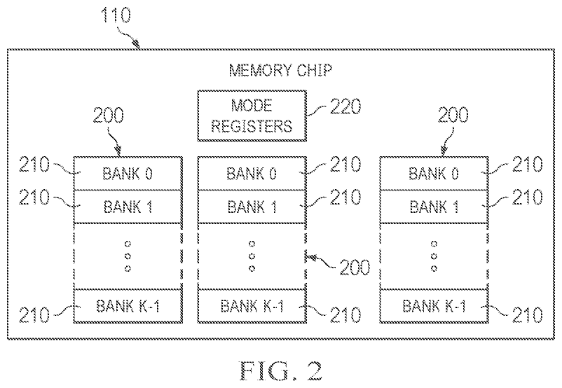

As shown in FIG. 1, each rank 118 may include a plurality of memory chips 110. Each memory chip 110 may include a packaged integrated circuit configured to comprise a plurality of memory cells for storing data. In some embodiments, a memory chip 110 may include dynamic random access memory (DRAM). Selected components of a memory chip 110 are illustrated in greater detail in FIG. 2 below.

Status registers 112 may include one or more configuration variables and/or parameters associated with memory system 104. When reading, writing, refreshing, and/or performing other operations associated with memory system 104, memory controller 108 may carry out such operations based at least in part on configuration parameters and/or variables stored in status registers 112. In some embodiments, status registers 112 may include registers similar to mode registers 220 (FIG. 2).

Storage medium 106 may be communicatively coupled to processor 104. Storage medium 106 may include any system, device, or apparatus operable to store information processed by processor 103. Storage medium 106 may include, for example, network attached storage, one or more direct access storage devices (e.g., hard disk drives), and/or one or more sequential access storage devices (e.g., tape drives). As shown in FIG. 1, storage medium 106 may have stored thereon an operating system (OS) 114. OS 114 may be any program of executable instructions, or aggregation of programs of executable instructions, configured to manage and/or control the allocation and usage of hardware resources such as memory, CPU time, disk space, and input and output devices, and provide an interface between such hardware resources and application programs hosted by OS 114. Active portions of OS 114 may be transferred to memory 104 for execution by processor 103.

In addition to processor 103, memory 104, and storage medium 106, information handling system 102 may include one or more other information handling resources.

FIG. 2 illustrates a block diagram of an example memory chip 110, in accordance with embodiments of the present disclosure. A memory chip 110 may include mode registers 220 and a plurality of bank groups 200. Each memory bank 210 may be a logical unit of storage within memory chip 110.

Mode registers 220 may include one or more configuration variables and/or parameters associated with memory chip 110. When reading, writing, refreshing, and/or performing other operations associated with memory system 104, a memory module 116 may carry out such operations based at least in part on configuration parameters and/or variables stored in mode registers 220. In some embodiments, mode registers 220 may be defined by a JEDEC standard for memory devices.

Each memory bank group 200 may comprise a plurality of memory banks 210. Each memory bank 210 may be a logical unit of storage within memory chip 110, and may include a plurality of memory cells. For clarity and exposition, FIG. 2 depicts memory chip 110 having three memory bank groups 200. However, memory chip 110 may include any suitable number of memory bank groups 200.

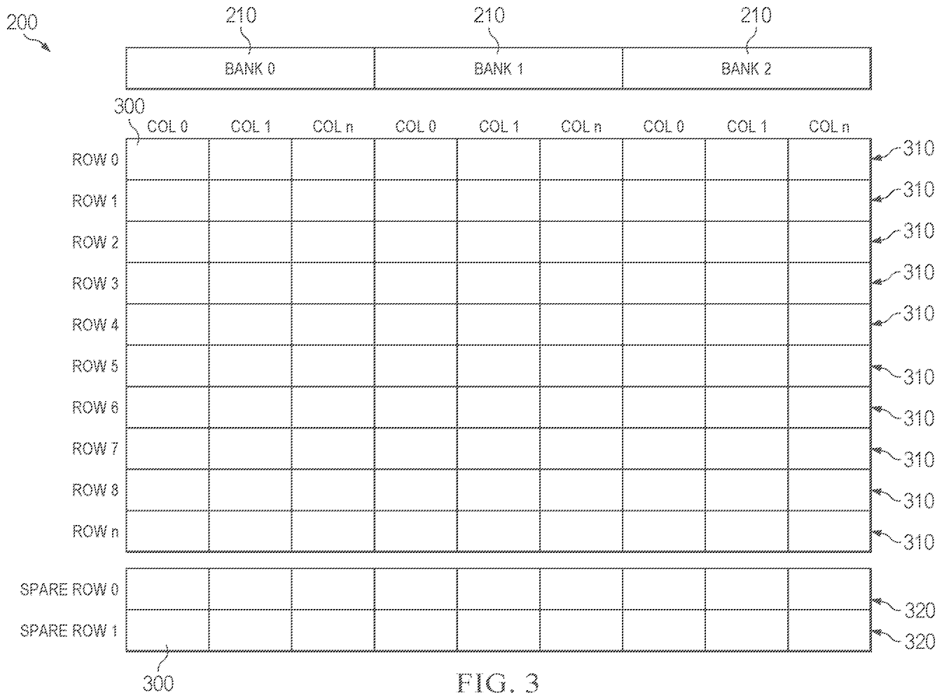

FIG. 3 illustrates a block diagram of an example bank group 200, in accordance with embodiments of the present disclosure. Bank group 200 may include a plurality of banks 210. As shown, the various banks 210 may be logically organized into a plurality of rows 310 of memory blocks 300 and spare rows 320 of memory blocks 300, wherein each row 310 and spare row 320 spans the various banks 210. For clarity and exposition, FIG. 3 depicts bank group 200 comprising two spare rows 320. However, bank group 200 may include any suitable number of spare rows 320.

In operation, operating system 114 and/or memory controller 108 may execute a memory self-healing optimization process, whereby the process may, responsive to the occurrence of a memory defect, decide between software-based or hardware-based (PPR) memory healing in order to maximize a number of bits that are repaired by a spare row 320, in order to maximize total available memory. For instance, the process may, by default, employ software-based memory healing in which software (e.g., a portion of operating system 114 or an application executing on operating system 114) may map out an entire block 300 (e.g., 4 KB) of memory responsive to the occurrence of a memory defect. However, once a threshold number of defects have occurred in a row 310, the process may apply PPR to replace the row 310 in question with a spare row 320. Thus, when PPR healing is applied to a row 310, memory regions of such row 310 mapped out by software-based memory healing may be reclaimed and added back to the total available memory, thus maximizing memory.

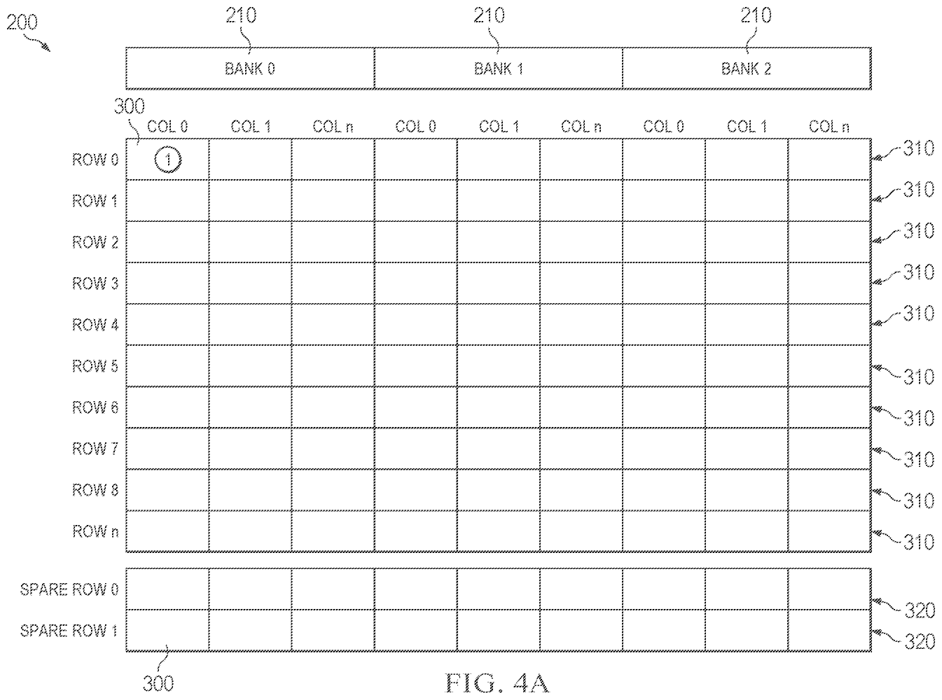

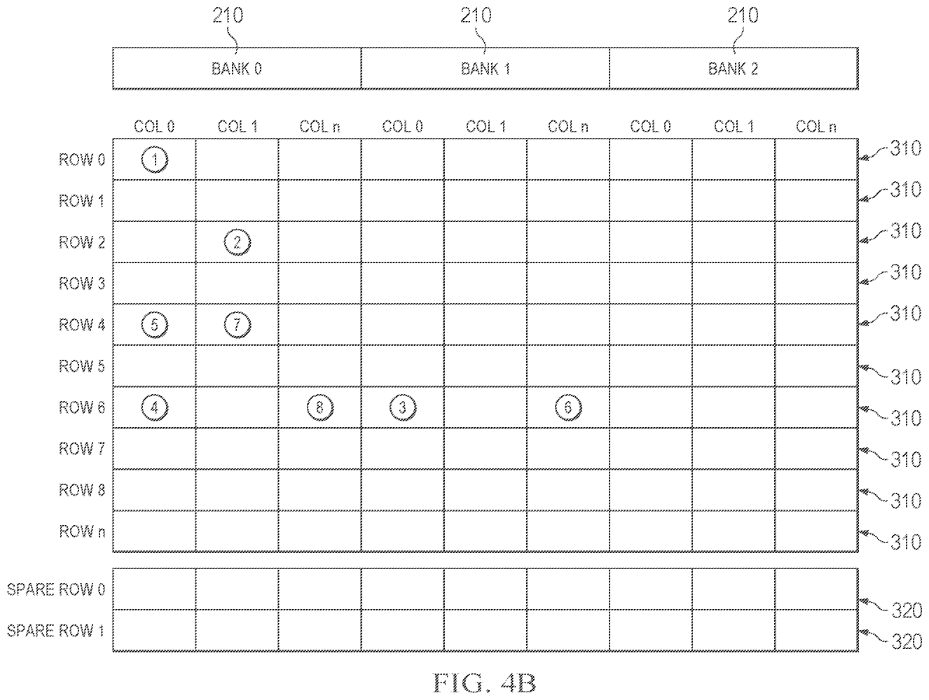

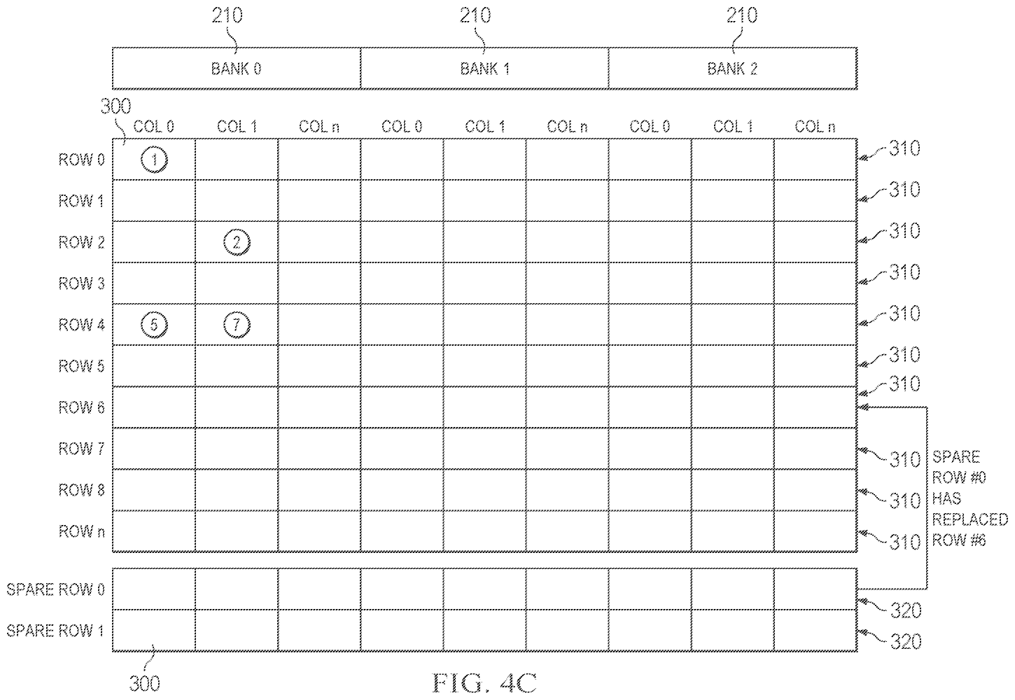

FIGS. 4A-4C illustrate the optimization process over time in response to a series of hypothetical memory defect occurrences, in accordance with embodiments of the present disclosure. In FIG. 4A, a memory defect 1 may occur at row 0, column 0 of bank 0. In response to memory defect 1, the optimization process may apply software-based healing to map out the block 300 at row 0, column 0 of bank 0, thus reducing the size of available memory. Afterwards, additional memory defects may occur:
a memory defect 2 occurring at row 2, column 1 of bank 0, which the process may remediate by applying software-based healing to map out the block 300 at row 2, column 1 of bank 0;
a memory defect 3 occurring at row 6, column 0 of bank 1, which the process may remediate by applying software-based healing to map out the block 300 at row 6, column 0 of bank 1;
a memory defect 4 occurring at row 6, column 0 of bank 0, which the process may remediate by applying software-based healing to map out the block 300 at row 6, column 0 of bank 0;
a memory defect 5 occurring at row 4, column 0 of bank 0, which the process may remediate by applying software-based healing to map out the block 300 at row 4, column 0 of bank 0;
a memory defect 6 occurring at row 6, column n of bank 1, which the process may remediate by applying software-based healing to map out the block 300 at row 6, column n of bank 1; and
a memory defect 7 occurring at row 4, column 1 of bank 0, which the process may remediate by applying software-based healing to map out the block 300 at row 4, column 1 of bank 0.

Upon occurrence of memory defect 8 occurring at row 6, column n of bank 0, row 6 may have reached the threshold for applying hardware-based PPR healing. Accordingly, as shown in FIG. 4C, the process may replace row 6 with spare row 0, which allows previously mapped-out memory blocks 300 associated with memory defects 3, 4, and 6 to added back to available memory.

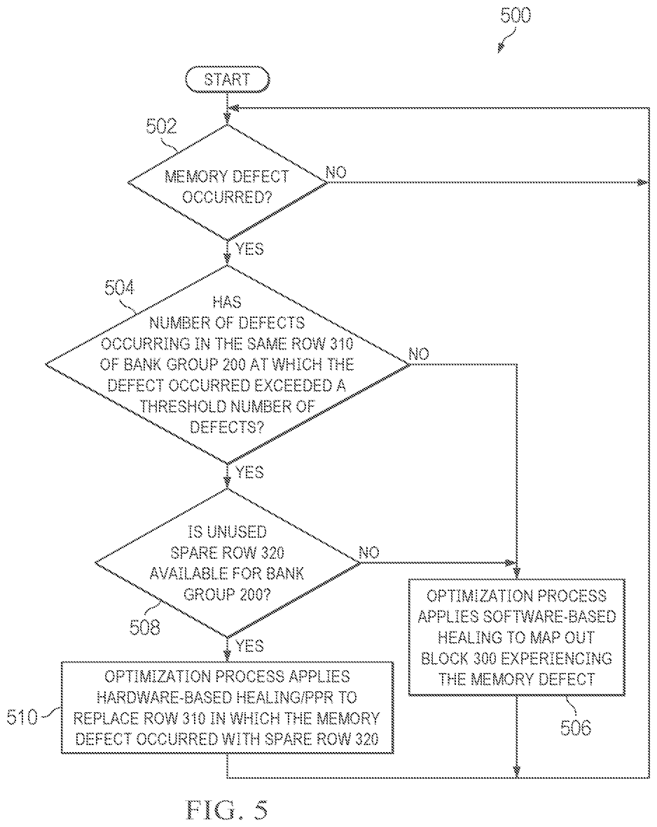

FIG. 5 illustrates a flow chart of an example method 500 for optimization of post package repair in association with software memory healing, in accordance with embodiments of the present disclosure. According to some embodiments, method 500 may begin at step 502. As noted above, teachings of the present disclosure may be implemented in a variety of configurations of information handling system 102. As such, the preferred initialization point for method 500 and the order of the steps comprising method 500 may depend on the implementation chosen.

At step 502, an optimization process executing on operating system 114 and/or memory controller 108 may determine if and where (e.g., which memory block 300) a memory defect has occurred. If a memory defect is detected, method 500 may proceed to step 504. Otherwise, method 500 may remain at step 502 until a memory defect is detected. At step 504, the optimization process may determine if the number of defects occurring in the same row 310 of the bank group 200 at which the defect occurred has exceeded a threshold number of defects. If the number of defects occurring in the same row 310 of the bank group 200 at which the defect occurred has exceeded a threshold number of defects, method 500 may proceed to step 508. Otherwise, method may proceed to step 506.

At step 506, the optimization process may apply software-based healing to map out the block 300 experiencing the memory defect. After completion of step 506, method 500 may proceed again to step 502.

At step 508, the optimization process may determine if an unused spare row 320 is available for bank group 200. If no unused spare row 320 is available, method 500 may proceed to step 506. Otherwise, method 500 may proceed to step 510.

At step 510, the optimization process may apply hardware-based healing/PPR to replace the row 310 in which the memory defect occurred with a spare row 320. After completion of step 510, method 500 may proceed again to step 502.

Although FIG. 5 discloses a particular number of steps to be taken with respect to method 500, method 500 may be executed with greater or fewer steps than those depicted in FIG. 5. In addition, although FIG. 5 discloses a certain order of steps to be taken with respect to method 500, the steps comprising method 500 may be completed in any suitable order.

Method 500 may be implemented using operating system 114, memory controller 108, and/or any other system operable to implement method 500. In certain embodiments, method 500 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

What is claimed is:

1. An information handling system comprising:
a processor;
a memory system communicatively coupled to the processor, the memory system comprising a plurality of spare rows for post-package repair of the memory system; and
one or more instructions stored in non-transitory computer readable media and configured to, when executed, cause the processor to:
communicate a command to the memory system requesting information associated with an availability of spare rows for post-package repair of the memory system; and
receive a response to the command, the command comprising the information associated with the availability.

2. The information handling system of claim 1, wherein the information comprises at least one of a number of available spare rows and a memory location of one or more available spare rows.

3. The information handling system of claim 1, wherein the command is implemented using an opcode compatible with a memory standard for the memory system.

4. The information handling system of claim 3, wherein the opcode is defined by the memory standard.

5. The information handling system of claim 3, wherein the opcode is a vendor-specific opcode.

6. The information handling system of claim 1, wherein the information associated with the availability comprises contents of one or more memory registers of the memory system.

7. A method comprising:
communicating a command to a memory system comprising a plurality of spare rows for post-package repair of the memory system, the command for requesting information associated with an availability of spare rows for post-package repair of the memory system; and
receiving a response to the command, the command comprising the information associated with the availability.

8. The method of claim 7, wherein the information comprises at least one of a number of available spare rows and a memory location of one or more available spare rows.

9. The method of claim 7, wherein the command is implemented using an opcode compatible with a memory standard for the memory system.

10. The method of claim 9, wherein the opcode is defined by the memory standard.

11. The method of claim 9, wherein the opcode is a vendor-specific opcode.

12. The method of claim 7, wherein the information associated with the availability comprises contents of one or more memory registers of the memory system.

13. An article of manufacture comprising:
a non-transitory computer-readable medium; and
computer-executable instructions carried on the computer-readable medium, the instructions readable by a processor, the instructions, when read and executed, for causing the processor to:
communicate a command to a memory system comprising a plurality of spare rows for post-package repair of the memory system, the command for requesting information associated with an availability of spare rows for post-package repair of the memory system; and
receive a response to the command, the command comprising the information associated with the availability.

14. The article of manufacture of claim 13, wherein the information comprises at least one of a number of available spare rows and a memory location of one or more available spare rows.

15. The article of manufacture of claim 13, wherein the command is implemented using an opcode compatible with a memory standard for the memory system.

16. The article of manufacture of claim 15, wherein the opcode is defined by the memory standard.

17. The article of manufacture of claim 15, wherein the opcode is a vendor-specific opcode.

18. The article of manufacture of claim 13, wherein the information associated with the availability comprises contents of one or more memory registers of the memory system.
